(19) United States
(12) Patent Application Publication
(10) Pub. No.: US 2014/0341235 A1
(43) Pub. Date: Nov. 20, 2014

(54) MULTIPLE ACCESS COMMUNICATION SYSTEM AND PHOTOVOLTAIC POWER GENERATION SYSTEM

(71) Applicants: Hitachi Industry & Control Solutions, Ltd., Hitachi-shi, Ibaraki (JP); National Institute of Advanced Industrial Science and Technology, Tokyo (JP)

(72) Inventors: Teruhiko Tagashira, Yokohama-shi (JP); Yukio Hiruta, Yokohama-shi (JP); Hiroshi Honjou, Yokohama-shi (JP); Sadao Nishizawa, Yokohama-shi (JP); Yuji Kasai, Tsukuba-shi (JP); Masahiro Murakawa, Tsukuba-shi (JP)

(21) Appl. No.: 14/374,215

(22) PCT Filed: May 17, 2013
(86) PCT No.: PCT/JP2013/003168

§ 371 Date: Jul. 23, 2014

(30) Foreign Application Priority Data
Aug. 17, 2012 (JP) 2012-180708

(51) Int. Cl. H04B 1/707; H04B 3/54

(52) U.S. Cl. CPC H04B 1/707; H04B 3/54
USPC 370/479

(57) ABSTRACT

Each transmitter (4) included in a first transmitter group (40A) transmits, on a first electric wire (2A), a current signal representing a change in current in accordance with a transmission bit sequence. Each transmitter (4) included in a second transmitter group (40B) transmits, on a second electric wire (2B) that is connected in parallel with the first electric wire, a current signal representing a change in current in accordance with a transmission bit sequence. A current detection unit (6A) outputs an electric signal representing a change in a difference current between a first current (IA) flowing through the first electric wire (2A) and a second current (IB) flowing through the second electric wire (2B). A receiver (5A) identifies and receives a reception bit sequence corresponding to the transmission bit sequence of each transmitter (4) included in the first and second transmitter groups, by processing the first electric signal.

### TECHNICAL FIELD

The present invention relates to a multiple access communication system.

### BACKGROUND ART

Patent Literature 1 discloses an SSMA (Spread Spectrum Multiple Access) communication system. The SSMA can also be called DS-CDMA (Direct-Spread Code-Division Multiple Access). In the communication system disclosed in Patent Literature 1, remote units perform spread spectrum modulating on a transmission bit sequence by using different spreading codes, and transmit the spread-spectrum-modulated transmission signal to a wired transmission line. Then a base unit performs despreading processing on a reception signal containing multiplexed transmission signals of the remote units, thereby identifying and receiving a reception bit sequence corresponding to the transmission bit sequence of each remote unit.

Patent Literature 1 also discloses an example in which the SSMA communication system described above is coupled to a photovoltaic power generation system. A typical photovoltaic power generation system includes a solar cell array in which solar cell panels (or solar cell modules) are connected in series and in parallel. The solar cell array includes solar cell strings connected in parallel, and each solar cell string includes solar cell panels connected in series. DC power generated by the solar cell array is transmitted to a power conditioner through power lines, and is converted into AC power by the power conditioner. The SSMA communication system disclosed in Patent Literature 1 can be used to monitor a state (e.g., an output voltage, an output current, or temperature, or a combination thereof) of each solar cell panel.

Each remote unit disclosed in Patent Literature 1 is, for example, disposed and coupled to one of solar cell panels. The remote unit generates a transmission frame in which monitoring information on a solar cell panel is encoded, and performs direct sequence spreading on respective bits of the transmission frame by using a spreading code pre-allocated to each remote unit, thereby generating a transmission signal. Then each remote unit transmits the transmission signal as a current signal. In other words, each remote unit superimposes a change in current which represents the transmission signal on a direct current flowing through a power line.

The base unit disclosed in Patent Literature 1 is, for example, disposed near the power conditioner. The base unit detects the current signals, which are transmitted from the plurality of remote units, as a voltage change between two power lines that are provided on a positive side and a negative side. Then the base unit performs despreading processing on the detected reception signal, thereby identifying and receiving the reception bit sequence corresponding to the transmission bit sequence of each remote unit.

Patent Literature 2 discloses a technique that uses a current transformer to monitor a current generated by a photovoltaic power generation system. Specifically, the system disclosed in Patent Literature 2 has a configuration in which two power lines, each connected to one of two solar cell strings, pass through the core of the current transformer in opposite directions. This allows the current transformer to detect a sum of two currents flowing through the two solar cell strings, by assuming that one of the two currents is treated as a positive value and the other of the two currents is treated as a negative value. Accordingly, the system disclosed in Patent Literature 2 can specify the solar cell string whose output current has decreased, based on a direction of change in the current detected by the current transformer.

### CITATION LIST

### Patent Literature

[PTL 1] Japanese Unexamined Patent Application Publication No. 2012-4626
[PTL 2] Japanese Unexamined Patent Application Publication No. 2011-187807

### SUMMARY OF INVENTION

### Technical Problem

The present inventors have found a problem as described below. For example, a large-scale photovoltaic power generation system uses a huge number of solar cell panels. Accordingly, it is necessary to use a number of remote units so as to individually monitor a number of solar cell panels by using the technique disclosed in Patent Literature 1. However, the number of multiple accesses in the SSMA communication system is limited by a spreading ratio (i.e., the length of a spreading code, the number of chips). Accordingly, for example, when the number of solar cell panels exceeds the spreading ratio, it may be difficult to monitor all the solar cell panels. On the other hand, when a spreading code having a large spreading ratio (i.e., having a large code length) is used to monitor all the solar cell panels, a reduction in bit rate may be caused.

Note that this above problem may occur not only in the SSMA communication system disclosed in Patent Literature 1, but also in other multiple access communication systems such as a TDMA (Time Division Multiple Access) system and an OFDMA (Orthogonal Frequency Division Multiple Access) system. This is because the resources (i.e., time, frequency, or spreading code, or a combination thereof) that are exclusively used for multiple accesses are limited. Further, this problem may occur not only in the case of monitoring a photovoltaic power generation system, but also in a wide range of communication systems (e.g., a power line communication system) that perform multiple access communication through electric wires connected in parallel.

Installation of a plurality of base units is one of the ways to address this problem. The use of a plurality of base units means that a plurality of multiple access communication systems are used. If the same resource can be shared (or reused) among the plurality of multiple access communication systems, there is a possibility that the above-mentioned problem caused due to the upper limit of the number of resources can be solved. However, the photovoltaic power generation system has a configuration in which a plurality of power lines respectively connected to solar cell strings (or solar cell arrays) are connected in parallel. Accordingly, a signal of a certain multiple access communication system causes an interference with a signal of another multiple access communication system through the plurality of lines connected in parallel.

The present invention has been made based on the above-mentioned findings by the inventors. Therefore, an object of the present invention is to be able to share (or reuse) the same resource among a plurality of multiple access systems which transmit signals on a plurality of electric wires (e.g., power lines) connected in parallel.

### Solution to Problem

In a first aspect, a multiple access communication system includes a plurality of electric wires, a plurality of transmitter groups, a first current detection unit, and a first receiver. The plurality of electric wires are connected in parallel and include first and second electric wires. The plurality of transmitter groups include a first transmitter group that transmits a signal on the first electric wire and a second transmitter group that transmits a signal on the second electric wire. Each of the transmitter groups includes at least one transmitter. Each transmitter operates to transmit, on one of the plurality of electric wires, a current signal representing a change in current in accordance with a transmission bit sequence. The first current detection unit operates to output a first electric signal representing a change in a difference current between a first current flowing through the first electric wire and a second current flowing through the second electric wire. The first receiver operates to identify and receive a reception bit sequence corresponding to the transmission bit sequence of each transmitter included in the first and second transmitter groups, by processing the first electric signal.

In a second aspect, a photovoltaic power generation system includes a multiple access communication system, a plurality of solar cell strings, and a power conditioner. Here, the multiple access communication system may have a configuration similar to that of the multiple access communication system according to the first aspect described above. The plurality of solar cell strings are respectively connected to the plurality of electric wires. The power conditioner receives DC power generated by the plurality of solar cell strings through the plurality of electric wires, and converts the DC power into AC power.

As described above, in the first and second aspects, the first electric signal, which represents a change in the difference current between the first current flowing through the first electric wire and the second current flowing through the second electric wire, is used to receive signals transmitted from the first and second transmitter groups. Accordingly, when the changes in the first and second currents are in phase, these changes cancel each other out in the difference current. The phrase “the changes in the first and second currents are in phase” means that the first and second currents increase together or decrease together, or that the signs (positive or negative) of time derivatives (i.e., gradients) of the first and second currents are the same. If the changes in the first and second currents are completely the same, no change occurs in the difference current.

On the other hand, when the changes in the first and second currents have opposite phases, these changes reinforce each other in the difference current. Specifically, when the changes in the first and second currents have opposite phases, these changes are detected as a change in the difference current. The phrase “the changes in the first and second currents have opposite phases” means that one of the first and second currents increases when the other of the first and second currents decreases, or that the signs (positive or negative) of the time derivatives (i.e., gradients) of the first and second currents are opposite to each other.

In the first and second aspects, the property of the change in the difference current is used to receive the transmission signals of the first and second transmitter groups connected respectively to the first and second electric wires, and is also used to substantially cancel the transmission signals of other transmitter groups respectively connected to other electric wires. For example, when the first transmitter group transmits current signals on the first electric wire, the first current changes in accordance with these current signals. Then a flow of electric charges (i.e., electrons) generated due to the change in the first current gives an opposite-phase change to the other electric wires including the second electric wire. When the first current increases due to the current signals superimposed by the first transmitter group, the flows of electrons through the second electric wire (and other electric wires) decrease, because a number of electrons are drawn into the first electric wire. For this reason, the change in the second current (and currents flowing through other electric wires) caused by the change in the first current has a phase opposite to that of the change in the first current. Thus, the change in the difference current between the first and second currents reflects the increase or decrease of the first current. This allows the first receiver to receive the transmission signals of the first transmitter group by using the first electric signal representing the change in the difference current between the first and second currents.

The transmissions of the second transmitter group are in the same manner as the transmission of the first transmitter group. Specifically, when the second transmitter group transmits current signals on the second electric wire, the second current increases or decreases due to the superimposed current signals. The change in the first current (and currents flowing through other electric wires) caused by the change in the second current has a phase opposite to that of the change in the second current. This allows the first receiver to receive the transmission signals of the second transmitter group by using the first electric signal representing the change in the difference current between the first and second currents.

On the other hand, when currents flowing through other electric wires increase or decrease due to the transmissions of other transmitter groups, the effects of these changes appear in both the first and second currents with the same phase. For example, when a current (referred to as a third current) flowing through another electric wire (referred to as a third electric wire) increases due to the current signals superimposed by another transmitter group (referred to as a third transmitter group), a number of electrons are drawn into the third electric wire, with the result that both flows of electrons through the first and second electric wires (and other electric wires) decrease together. For this reason, the changes in the first and second currents (and currents flowing through other electric wires) due to the increase or decrease of the third current are in phase. Accordingly, the changes in the first and second currents caused by the increase or decrease of the third current are substantially cancelled and do not appear in the change in the difference current between the first and second currents. This allows the first receiver to receive the transmission signals of the first and second transmitter groups without being affected by the transmission signals of the third transmitter group.

As understood from the above description, the first and second transmitter groups that use the first and second electric wires can share resources (i.e., time, frequency, or spreading code, or a combination thereof) with other transmitter groups that use other electric wires. This is because the interference of transmission signals (current signals) from the other transmitter groups can be substantially cancelled in the difference current between the first and second currents.

### Advantageous Effects of Invention

According to the first and second aspects described above, the same resource can be shared (or reused) among a plurality of multiple access systems transmit signals on a plurality of electric wires (e.g., power lines) connected in parallel.

### BRIEF DESCRIPTION OF DRAWINGS

FIG. 1 is a block diagram showing a configuration example of a photovoltaic power generation system according to a first embodiment;

FIG. 2 is a block diagram showing a configuration example of a remote unit according to the first embodiment;

FIG. 3 is a block diagram showing a configuration example of a base unit according to the first embodiment;

FIG. 4 is a waveform diagram showing a first example of phase inversion processing on a reception bit sequence;

FIG. 5 is a waveform diagram showing a second example of phase inversion processing on a reception bit sequence;

FIG. 6 is a waveform diagram showing a third example of phase inversion processing on a reception bit sequence;

FIG. 7 is a waveform diagram showing a fourth example of phase inversion processing on a reception bit sequence;

FIG. 8 is a diagram showing an example of a fixed bit pattern according to a second embodiment;

FIG. 9 is a flowchart showing an example of an inversion detection operation by a base unit according to the second embodiment;

FIG. 10 is a block diagram showing a configuration example of a photovoltaic power generation system according to a third embodiment;

FIG. 11A is a block diagram showing a configuration example of a photovoltaic power generation system according to a fourth embodiment; and

FIG. 11B is a block diagram showing a configuration example of the photovoltaic power generation system according to the fourth embodiment.

### DESCRIPTION OF EMBODIMENTS

Hereinafter, specific embodiments will be described in detail with reference to the drawings. In the drawings, identical or corresponding elements are denoted by the same reference numerals, and a repeated explanation is omitted as appropriate for clarity of the explanation.

### First Embodiment

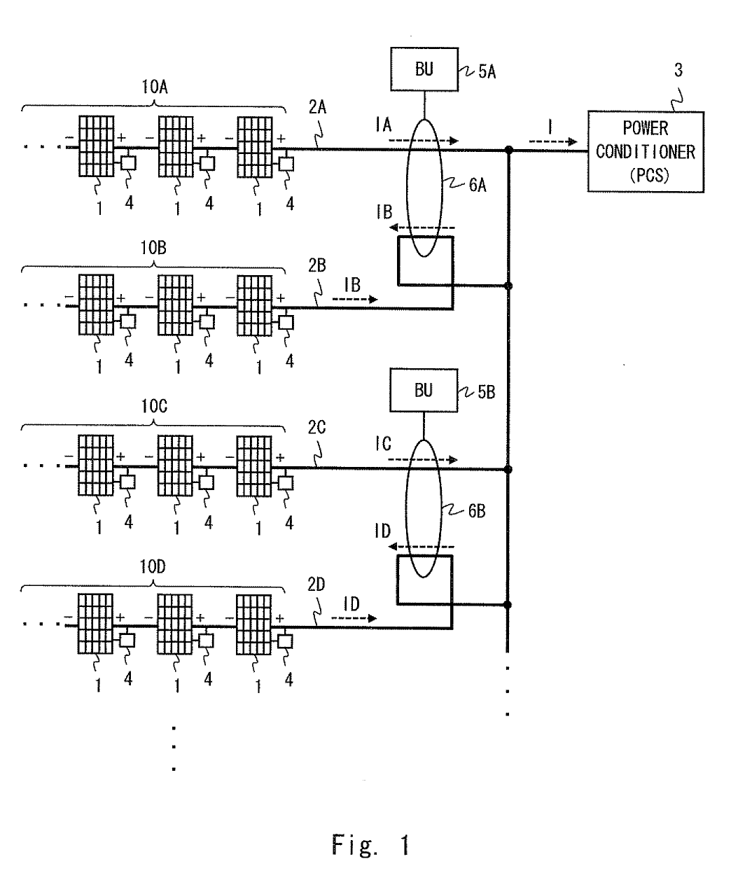

FIG. 1 is a block diagram showing a configuration example of a photovoltaic power generation system according to this embodiment. The system shown in FIG. 1 includes solar cell strings 10 including solar cell strings 10A to 10D. Each solar cell string 10 includes solar cell panels 1 which are connected in series. The solar cell strings 10 are connected in parallel by DC power lines 2 including DC power lines 2A to 2D. A power conditioner 3 receives DC power (DC voltage and direct current), which is generated by the solar cell strings 10, through the DC power lines 2 connected in parallel, and converts the DC power into AC power (AC voltage and alternating current).

Referring to FIG. 1, a current IA represents a current flowing through the DC power line 2A, i.e., a current flowing through the solar cell string 10A. Similarly, currents IB, IC, and ID respectively represent a current flowing through the DC power line 2B (i.e., the solar cell string 10B), a current flowing through the DC power line 2C (i.e., the solar cell string 10C), and a current flowing through the DC power line 2D (i.e., the solar cell string 10D). A current I is a summed current of direct currents, including the currents IA to ID, flowing through the solar cell strings 10. The current I represents a direct current to be supplied to the power conditioner 3.

FIG. 1 illustrates only the DC power lines 2 that connect the power conditioner 3 to the positive side of each solar cell string 10, while an illustration of DC power lines that connect the power conditioner 3 to the negative side of each solar cell string 10 is omitted. FIG. 1 illustrates the four solar cell strings 10A to 10D. The photovoltaic power generation system shown in FIG. 1 may include a larger number of solar cell strings 10, or may include only two or three solar cell strings 10.

In the example shown in FIG. 1, a multiple access communication system including a single base unit (BU) 5 and a plurality of remote units (RU) 4 is used to monitor states (e.g., output voltages, output currents, or temperatures, or a combination thereof) of the solar cell panels 1. FIG. 1 illustrates two multiple access communication systems. One of the multiple access communication systems includes a base unit 5A and a plurality of remote units 4 connected to the solar cell strings 10A and 10B (power lines 2A and 2B). The other multiple access communication system includes a base unit 5B and a plurality of remote units 4 connected to the solar cell strings 10C and 10D (power lines 2C and 2D). A group of remote units 4 connected to a single solar cell string 10 is hereinafter referred to as a “remote unit (RU) group”.

Each remote unit 4 generates a transmission bit sequence in which monitoring data indicative of a state of each solar cell panel 1 is encoded, and transmits, on any one of the DC power lines 2A to 2D, a current signal representing a change in current in accordance with the transmission bit sequence. In other words, each remote unit 4 superimposes the change in current in accordance with the transmission bit sequence on the direct current flowing through the corresponding DC power line 2.

The base unit 5 identifies and receives a reception bit sequence corresponding to the transmission bit sequence from each remote unit 4. Specifically, the base unit 5A shown in FIG. 1 communicates with the remote units 4 belonging to the two RU groups respectively connected to the power lines 2A and 2B. Similarly, the base unit 5B shown in FIG. 1 communicates with the remote units 4 belonging to the two RU groups respectively connected to the power lines 2C and 2D.

As a transmission scheme between the remote units 4 and the base units 5, a baseband transmission using no carrier signal, or a carrier-modulated transmission modulating a carrier signal may be used. When the baseband transmission is employed, each remote unit 4 may generate a transmission signal by, for example, NRZ (Non Return to Zero) encoding for directly assigning values of the transmission bit sequence to two current levels. When the carrier-modulated transmission is employed, each remote unit 4 may map transmission symbols to the transmission bit sequence and transmit a current signal representing a change in current in accordance with the transmission symbols. A modulation scheme used when the carrier-modulated transmission is employed is not limited to a particular modulation scheme, and any modulation scheme that can be employed in wired transmission lines, such as power lines, can be utilized. For example, each remote unit 4 may superimpose, on the direct current flowing through the corresponding DC power line 2, a change in current representing a carrier signal modulated using OOK (On Off Keying), ASK (Amplitude Shift Keying), FSK (Frequency Shift Keying), or PSK (Phase Shift Keying).

Further, a multiple access scheme between the remote units 4 and the base unit 5 is not limited to a particular scheme, and any scheme that can be employed in wired transmission lines, such as power lines, can be utilized. For example, the multiple access scheme employed in this embodiment may be SSMA (DS-CDMA), TDMA, FDMA, or OFDMA, or a combination thereof.

As described above, the photovoltaic power generation system as shown in FIG. 1 has a configuration in which the DC power lines 2 respectively connected to the solar cell strings 10 are connected in parallel. Accordingly, the signals from one multiple access communication system including the base unit 5B shown in FIG. 1 interfere with the signals of another multiple access communication system including the base unit 5A, via the DC power lines 2 connected in parallel. Therefore, some measures need to be taken to share the same resource (i.e., time, frequency, or spreading code, or a combination thereof) among multiple access systems which transmit signals on the power lines 2A to 2D connected in parallel.

To address this problem, this embodiment uses a current transformer (CT) 6. In the CT 6, induced current is generated in a secondary coil in accordance with a change in a magnetic flux (i.e., a changing rate of a magnetic flux or a time derivative of a magnetic flux) in an annular core of the CT 6 produced by a current flowing through an electric wire (i.e., a primary coil) passing through the annular core. The CT 6 causes the induced current generated in the secondary coil to flow through a load resistor, thereby outputting a voltage signal corresponding to the induced current. The CT 6 is a specific example of a current detection unit that outputs an electric signal representing a change in a difference current between a first current flowing through a first electric wire and a second current flowing through a second electric wire.

A CT 6A shown in FIG. 1 generates an electric signal representing a change in the difference current between the current IA flowing through the power line 2A and the current IB flowing through the power line 2B. Specifically, the two power lines 2A and 2B pass through the annular core of the CT 6A in opposite directions. Accordingly, the direct current IA flowing through the power line 2A from the solar cell string 10A toward the power conditioner 3 passes through the annular core of the CT 6A from the left side to the right side on the drawing sheet of FIG. 1. On the other hand, the direct current IB flowing through the power line 2B from the solar cell string 10B toward the power conditioner 3 passes through the annular core of the CT 6A from the right side to the left side on the drawing sheet of FIG. 1. Then when the changes in the direct currents IA and IB are in phase, the directions of the magnetic fluxes that are generated in the core of the CT 6A by the currents IA and IB are opposite to each other and the magnetic fluxes cancel each other out. The phrase “the changes in the currents IA and IB are in phase” means that both the currents IA and IB increase together or decrease together, or that the signs (positive or negative) of time derivatives (i.e., gradients) of the currents IA and IB are the same. If the changes in the currents IA and IB are completely the same, no change occurs in the difference current.

On the other hand, when the changes in the direct currents IA and IB have opposite phases, the directions of the magnetic fluxes induced in the core by the currents IA and IB are the same, and thus the magnetic fluxes reinforce each other. The phrase “the changes in the currents IA and IB have opposite phases” means that one of the currents IA and IB increases when the other of the currents IA and IB decreases, or that the signs (positive or negative) of the time derivatives (i.e., gradients) of the currents IA and IB are opposite to each other.

In this embodiment, an electric signal according to a change in the difference current between the currents IA and IB is generated using the CT 6A, and the electric signal is supplied to the base unit 5A. This allows the base unit 5A to receive the transmission signals of the two RU groups respectively connected to the power lines 2A and 2B, and to substantially cancel the transmission signals of other RU groups respectively connected to the other power lines 2C and 2D. The term “substantially cancel” herein mentioned means that the transmission signals of other RU groups need not be completely cancelled so that the transmission signals of other RU groups become zero. In other words, the term “substantially cancel” means that the transmission signal levels of other RU groups respectively connected to the other power lines 2C and 2D are small enough to be able to receive the transmission signals of the two RU groups respectively connected to the power lines 2A and 2B at a predetermined quality (e.g., an SNR (Signal to Noise Ratio), a bit error ratio).

For example, when the RU group (referred to as “RU group A”) connected to the DC power line 2A transmits current signals, the direct current IA changes in accordance with these current signals. A flow of electric charges (i.e., electrons) due to the change in the current IA gives an opposite-phase change to the other power lines 2 including the power line 2B. When the direct current IA increases due to the current signals superimposed by the RU group A, a number of electrons are drawn into the power line 2A, with the result that the flows of electrons through the power line 2B (and other power lines 2C and 2D) decrease. Accordingly, the change in the direct current IB (and the currents IC and ID flowing through other power lines) caused by the change in the direct current IA has a phase opposite to that of the change in the current IA. Thus, the electric signal output from the CT 6A, i.e., the electric signal representing the change in the difference current between the direct currents IA and IB, reflects the increase or decrease of the direct current IA. This allows the base unit 5A to receive the transmission signal of the RU group A, which is connected to the DC power line 2A, by using the electric signal from the CT 6A.

The transmissions of an RU group connected to the DC power line 2B (the RU group is referred to as “RU group B”) are in the same manner as the transmission of the RU group A. Specifically, when the RU group B transmits current signals on the power line 2B, the direct current IB increases or decreases due to the superimposed current signal. The change in the direct current IA (and the currents IC and ID flowing through other power lines) caused by the change in the direct current IB has a phase opposite to that of the change in the current IB. This allows the base unit 5A to receive the transmission signals from the RU group B by using the output signal of the CT 6A which represents the change in the difference current between the direct currents IA and IB.

On the other hand, when the direct currents IC and ID flowing respectively through the power lines 2C and 2D increase or decrease due to the transmission of RU groups connected respectively to the power lines 2C and 2D (the RU groups are referred to as “RU groups C and D”), the effects of these changes appear with the same phase in both the direct currents IA and IB flowing respectively through the electric wires 2A and 2B. When the direct current IC flowing through the power line 2C increases due to the current signals superimposed by the RU group C, a number of electrons are drawn into the power line 2C, with the result that both flows of electrons through the power lines 2A and 2B decrease together. Thus the changes in the direct currents IA and IB caused by the increase or decrease of the direct current IC are in phase. Accordingly, the changes in the direct currents IA and IB caused by the increase or decrease of the direct current IC substantially cancelled and do not appear in the output signal of the CT 6A which represents the change in the difference current between the currents IA and IB. Similarly, the current signals transmitted on the power line 2D by the RU group D are also substantially cancelled without appearing in the output signal of the CT 6A. This allows the base unit 5A to receive the transmission signals of the RU groups A and B without being affected by the transmission signals of the RU groups C and D.

As understood from the above description, two RU groups A and B that use the power lines 2A and 2B can share the resources with the other RU groups C and D that use the other power lines 2C and 2D. This is because the interference from the transmission signals (current signals) of the other RU groups C and D is substantially cancelled in the difference current between the direct currents IA and IB.

In the communication using the power lines 2, noise generated by equipment associated with the photovoltaic power generation system, such as switching noise of the power conditioner 3 and a modulation component generated due to a maximum power point tracking operation by the power conditioner 3, is superimposed on the current flowing through the power line 2. The effects of the noise from the power conditioner 3 appear with the same phase in the power lines 2A to 2D connected in parallel. Accordingly, the base unit 5A can suppress the deterioration in reception quality due to the noise from the power conditioner 3, by using the electric signal output from the CT 6A. This is because the noise from the power conditioner 3 is substantially cancelled in the difference current between the direct currents IA and IB.

Similarly, the two power lines 2C and 2D pass through the annular core of the CT 6B in opposite directions. This allows the CT 6B to generate an electric signal representing a change in the difference current between the current IC flowing through the power line 2C and the current ID flowing through the power line 2D. Accordingly, the base unit 5B can receive the transmission signals of the RU groups C and D without being affected by the transmission signals of the RU groups A and B. Further, the base unit 5B can suppress the deterioration in reception quality due to the noise from the power conditioner 3.

The layout of the CTs 6A and 6B shown in FIG. 1 is merely an example for detecting a change in the difference current between the currents flowing through two power lines 2. Other layout examples of the CT(s) 6 will be given in other embodiments to be described later.

Next, configuration examples of the remote unit 4 and the base unit 5 will be described below. The configuration examples herein described are illustrated by way of example only. The remote unit 4 and the base unit 5 may be configured, for example, in the same manner as the remote unit and the base unit disclosed in Patent Literature 1.

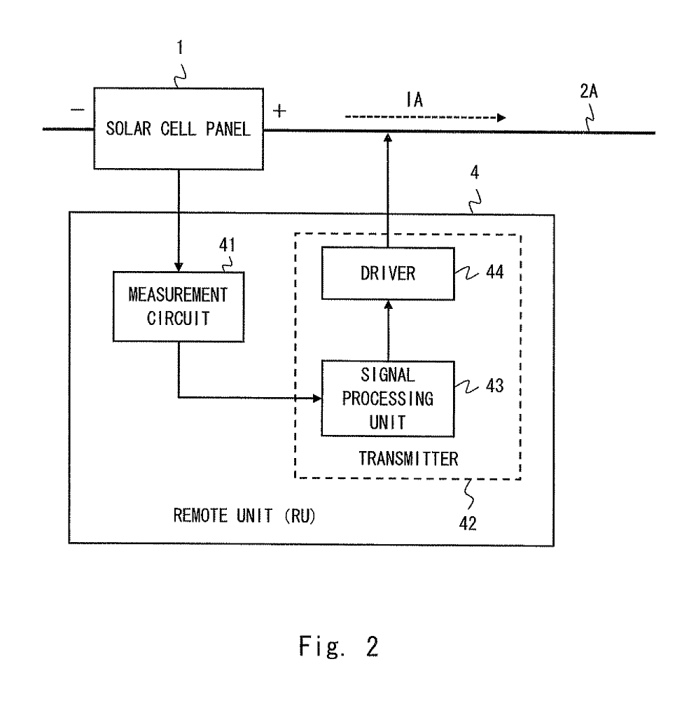

FIG. 2 is a block diagram showing a configuration example of the remote unit 4 connected to the power line 2A. The remote unit 4 shown in FIG. 2 includes a measurement circuit 41 and a transmitter 42. The measurement circuit 41 measures a state (e.g., an output voltage, an output current, or temperature, or a combination thereof) of the solar cell panel 1. The measurement circuit 41 includes, for example, a voltage sensor, a current sensor or a temperature sensor.

The transmitter 42 superimposes, on the direct current IA flowing through the DC power line 2A, the current signal in which measurement data (i.e., monitoring data on the solar cell panel 1) of the measurement circuit 41 is encoded. In the example shown in FIG. 2, the transmitter 42 includes a signal processing unit 43 and a driver 44. The signal processing unit 43 receives the measurement data from the measurement circuit 41, and generates a transmission bit sequence in which the measurement data is encoded. For example, the signal processing unit 43 constructs a transmission frame including a payload containing measurement data, and performs transmission line encoding (e.g., addition of an error correction code) on the transmission frame, thereby generating a transmission bit sequence. In the case of performing the carrier-modulated transmission, the signal processing unit 43 may perform digital modulation processing by using the transmission bit sequence. In other words, the signal processing unit 43 may generate a transmission symbol sequence by mapping modulation symbols to the transmission bit sequence. When the SSMA is employed as the multiple access scheme, the signal processing unit 43 may generate a transmission chip sequence by performing direct sequence spreading (spread-spectrum modulation) on the transmission bit sequence by using predetermined spreading code. The signal processing unit 43 provides a digital transmission signal indicating a transmission bit sequence (or a transmission symbol sequence or a transmission chip sequence generated based on the transmission bit sequence) to the driver 44.

The driver 44 transmits, on the DC power line 2A, a current signal based on the digital transmission signal. In other words, the driver 44 superimposes, on the direct current IA flowing through the power line 2A, a change in current in accordance with the digital transmission signal based on the transmission bit sequence.

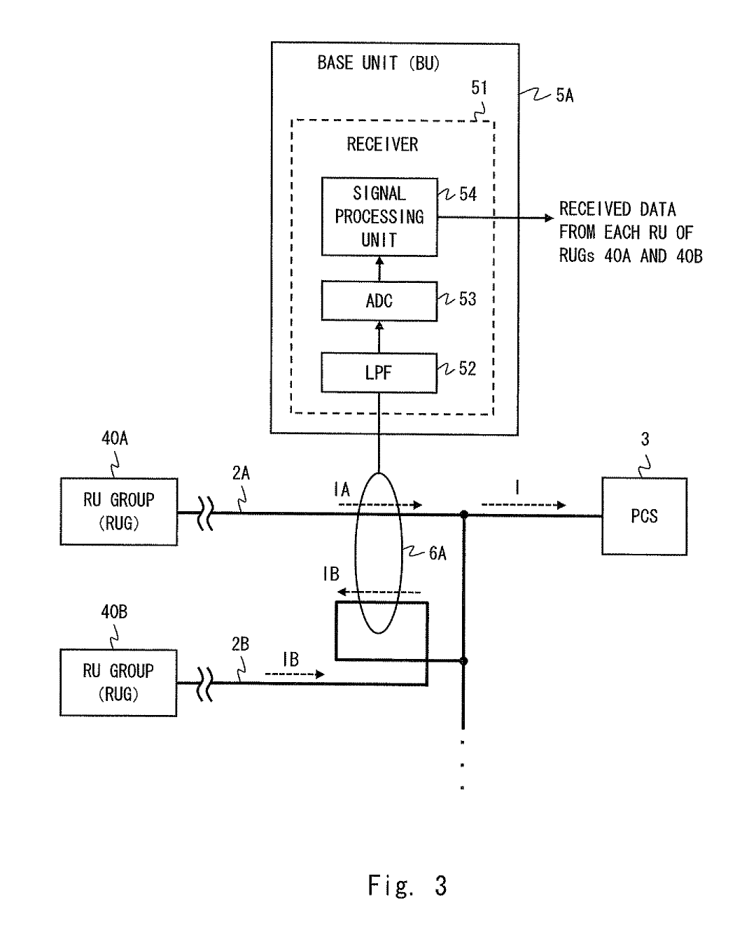

FIG. 3 is a block diagram showing a configuration example of the base unit 5A. The base unit 5A shown in FIG. 1 includes a receiver 51. The receiver 51 shown in FIG. 3 is connected to the secondary coil of the CT 6A, and detects the output of the CT 6A as a voltage signal. In the example shown in FIG. 3, the receiver 51 includes a low-pass filter (LPF) 52, an AD converter (ADC) 53, and a signal processing unit 54. The LPF 52 limits the bandwidth of the reception signal so as to prevent aliasing noise from being generated in the ADC 53. The ADC 53 samples an output signal of the LPF 52 and converts this signal into a digital signal.

The signal processing unit 54 processes the digital reception signal supplied from the ADC 53, and identifies and receives a reception bit sequence corresponding to the transmission bit sequence from each remote unit 4 included in the RU groups A and B (RU groups 40A and 40B in FIG. 3) that are respectively connected to the power lines 2A and 2B. Further, the signal processing unit 54 generates the received data (i.e., monitoring data on each solar cell panel 1) from the reception bit sequence. The received monitoring data is, for example, sent to an external monitoring server (not shown).

The signal processing unit 43 and the signal processing unit 54 shown in FIGS. 2 and 3 each may be implemented using a computer such as a microcomputer, a microcontroller, a microprocessor, a CPU (Central Processing Unit), or a system LSI (Large Scale Integration). For example, the signal processing unit 43 may be implemented as a one-chip microcomputer including the function of the signal processing unit 43. The signal processing unit 54 may be implemented as a one-chip microcomputer including the functions of the signal processing unit 54 and the ADC 53.

Subsequently, reception processing by the base unit 5 will be described in detail below. For example, in the reception signal of the base unit 5A shown in FIGS. 1 and 3, the logic of the reception bit sequence associated with the RU group B (40B) connected to the power line 2B is inverted as compared with the transmission bit sequence transmitted by the RU group B (40B). This is because the direct current IB, on which the transmission signal of the RU group B (40B) is superimposed, passes through the core of the CT 6A in the direction opposite to that of the current IA. To address this problem, for example, the base unit 5A may perform phase inversion processing on the reception bit sequence. Alternatively, this problem can be addressed by the RU group B (40B) that is adapted to generate a transmission signal (current signal) based on a signal whose phase is inverted relative to the transmission bit sequence.

In the case of performing the phase inversion processing on the reception bit sequence, the base unit 5A may process the reception signal according to any of the following methods (1) to (4).

(1) Inverting the phase (sign) of the reception bit sequence generated from the output signal of the CT 6A.

(2) Inverting the sign of a spreading code used for despreading processing to obtain the reception bit sequence.

(3) Inverting the phase of a reception symbol sequence or a reception chip sequence generated from the output signal of the CT 6A.

(4) Changing a method for determining a symbol used for demodulation processing to obtain the reception bit sequence.

In the case of performing the phase inversion processing on the transmission bit sequence, the remote unit 4 may process the transmission signal according to any of the following methods (5) to (8):

(5) Inverting the phase (sign) of the transmission bit sequence itself.

(6) Inverting the sign of a spreading code used for a direct sequence spreading on the transmission bit sequence.

(7) Inverting the phase of a transmission symbol sequence or a transmission chip sequence.

(8) Changing a symbol mapping rule for obtaining the transmission symbol sequence.

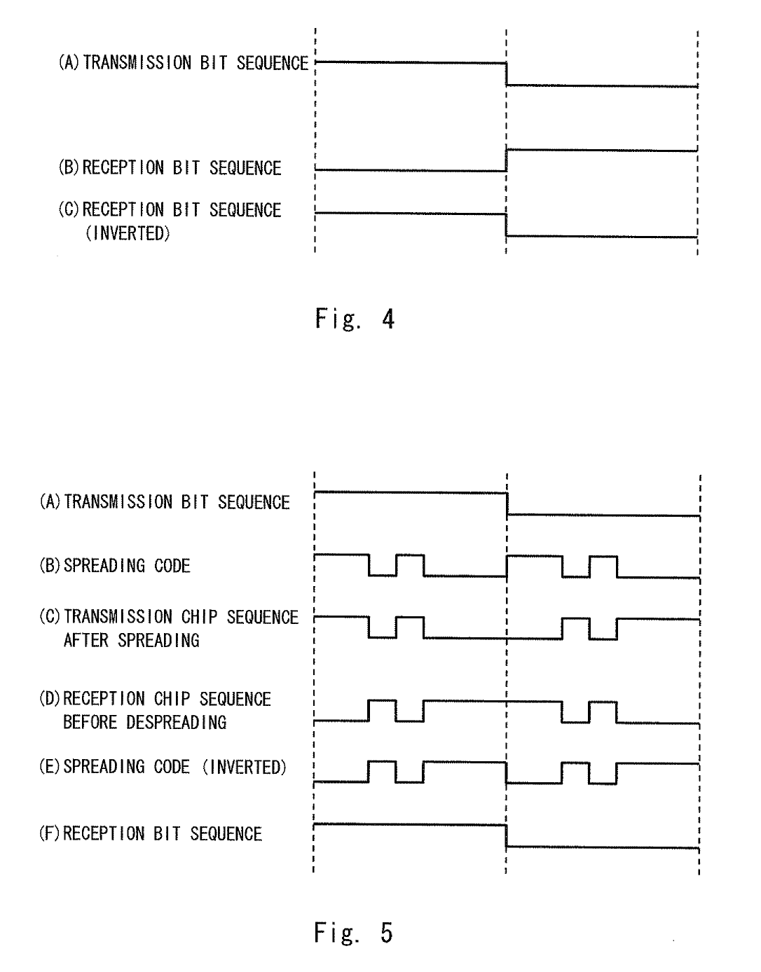

FIG. 4 is a signal waveform diagram showing an example of the above-mentioned method (1). FIG. 4(A) shows a 2-bit transmission bit sequence transmitted by the remote unit 4 included in the RU group B (40B). FIG. 4(B) shows a reception bit sequence corresponding to the transmission bit sequence of FIG. 4(A) which has been received without any error by the base unit 5A. The logic of the reception bit sequence of FIG. 4(B) is inverted relative to the logic of the transmission bit sequence of FIG. 4(A). Accordingly, the base unit 5A inverts the sign of the reception bit sequence itself. FIG. 4(C) shows a reception bit sequence obtained after the sign inversion. Thus, the base unit 5A can obtain the reception bit sequence in which the logic of the transmission bit sequence is correctly reflected.

FIG. 5 is a signal waveform diagram showing an example of the above-mentioned method (2). As understood from the fact that a spreading code is used, the method (2) can be used when the SSMA is employed as the multiple access scheme. FIG. 5(A) shows a 2-bit transmission bit sequence transmitted by the remote unit 4 included in the RU group B (40B). FIG. 5(B) shows a spreading code used for the remote unit 4 to perform direct sequence spreading on the transmission bit sequence. FIG. 5(C) shows a transmission chip sequence obtained after the direct sequence spreading. FIG. 5(D) shows a reception chip sequence which has been received without any error by the base unit 5A. The logic of the reception chip sequence of FIG. 5(D) is inverted relative to the logic of the transmission chip sequence of FIG. 5(C). Accordingly, the base unit 5A performs despreading using the spreading code, whose sign is inverted, as shown in FIG. 5 (E). FIG. 5(F) shows a reception bit sequence obtained after the despreading. This allows the base unit 5A to obtain the reception bit sequence in which the logic of the transmission bit sequence is correctly reflected.

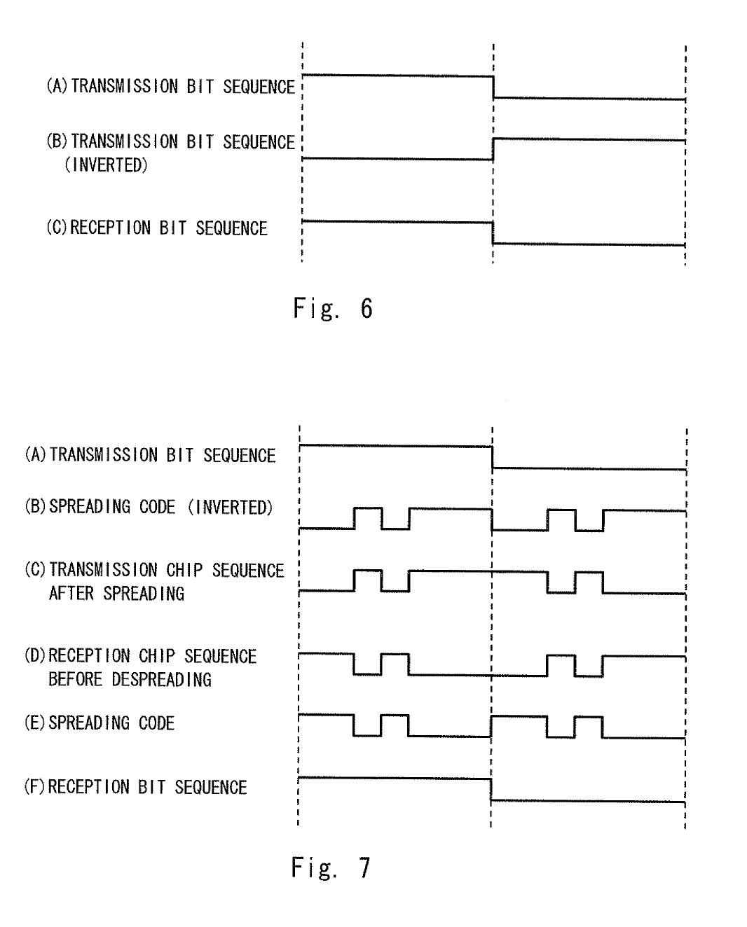

FIG. 6 is a signal waveform diagram showing an example of the above-mentioned method (5). FIG. 6 (A) shows a 2-bit transmission bit sequence transmitted by the remote unit 4 included in the RU group B (40B). FIG. 6(B) shows a bit sequence obtained by inverting the sign of the transmission bit sequence of FIG. 6(A). The remote unit 4 transmits a current signal based on the inverted transmission bit sequence shown in FIG. 6(B). FIG. 6(C) shows a reception bit sequence which has been received without any error by the base unit 5A. The sign of the transmission bit is inverted in advance on the side of the remote unit 4, which allows the base unit 5A to obtain the reception bit sequence (FIG. 6(C)) in which the logic of the transmission bit sequence (FIG. 6(A)) is properly reflected.

FIG. 7 is a signal waveform diagram showing an example of the above-mentioned method (6). The method (6) can be used when the SSMA is employed as the multiple access scheme. FIG. 7(A) shows a 2-bit transmission bit sequence transmitted by the remote unit 4 included in the RU group B (40B). FIG. 7(B) shows the spreading code, whose sign is inverted, for use in the direct sequence spreading on the transmission bit sequence by the remote unit 4. FIG. 7(C) shows a transmission chip sequence obtained after the direct sequence spreading. FIG. 7(D) shows a reception chip sequence which has been received without any error by the base unit 5A. The base unit 5A performs despreading by using the spreading code (FIG. 7(E)) whose sign is NOT inverted. FIG. 7(F) shows a reception bit sequence obtained after the despreading. This allows the base unit 5A to obtain the reception bit sequence in which the logic of the transmission bit sequence is correctly reflected.

### Second Embodiment

In this embodiment, a modified example of “phase inversion processing on the reception bit sequence” described in the first embodiment will be described. Configuration examples of the photovoltaic power generation system and the multiple access communication system according to this embodiment may be similar to those shown in FIGS. 1 to 3.

The first embodiment illustrates an example in which the base unit 5A performs phase inversion processing on the reception bit sequence (e.g., any of the methods (1) to (4)). When this method is employed, the base unit 5 needs to know which of the reception bit sequences from the remote units 4 is inverted by the CT 6. For example, an operator may set, in the base unit 5, information identifying the remote units 4 from which the reception bit sequences should be inverted. However, the workload of the setting work by the operator is increased when a large number of solar cell panels 1 should be monitored. Further, there is a fear that the setting work by the operator may cause setting errors.

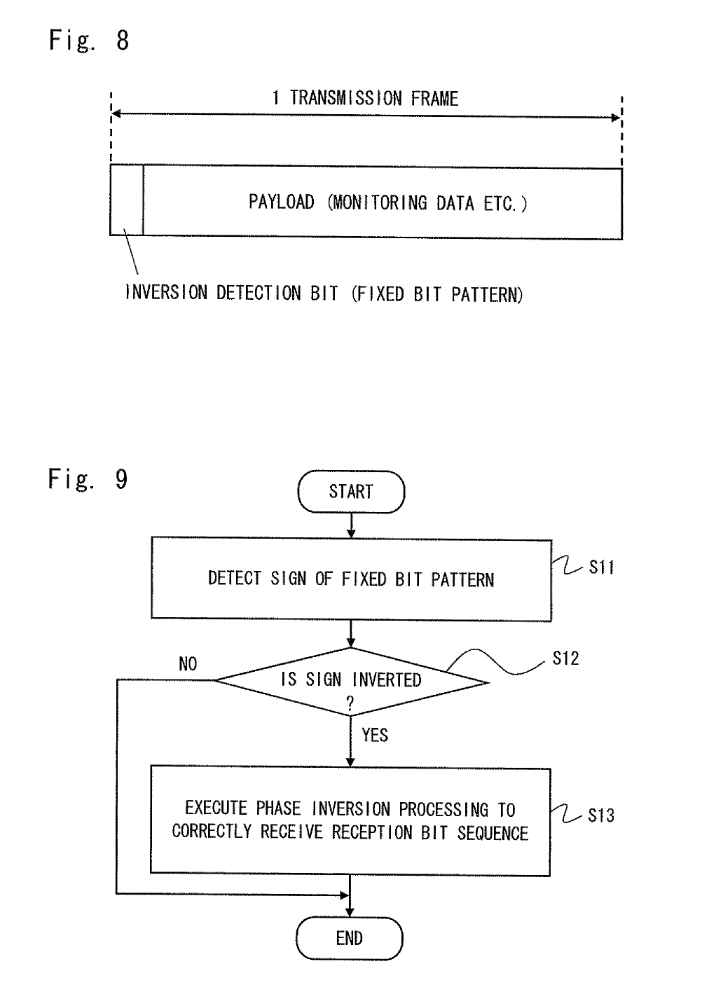

Therefore, the base unit 5 according to this embodiment automatically determines which of the reception bit sequences from the remote units 4 should be inverted. For this automatic determination, each remote unit 4 according to this embodiment generates a transmission bit sequence including a predetermined bit pattern (hereinafter, a “fixed bit pattern”) having at least a 1-bit length. For example, as shown in FIG. 8, each remote unit 4 can generate a transmission frame including a fixed bit pattern disposed at a predetermined position. In the example shown in FIG. 8, an inversion detection bit having a 1-bit length is disposed at the head position of the transmission frame, as the fixed bit pattern. The payload of the transmission frame includes, for example, monitoring data on each solar cell panel 1.

The receiver 51 of the base unit 5 detects the sign (bit logic) of the fixed bit pattern included in the reception bit sequence associated with each remote unit 4. Then the receiver 51 selectively performs the phase inversion processing (e.g., any of the methods (1) to (4)) on the reception bit sequence having the fixed bit pattern whose sign is inverted.

FIG. 9 is a flowchart showing an example of the inversion detection operation of the base unit 5 according to this embodiment. In step S11, the base unit 5 detects the sign of the fixed bit pattern contained in the reception bit sequence of the corresponding remote unit 4. When the inversion of the sign of the fixed bit pattern is detected (YES in step S12), the base unit 5 performs phase determination processing (e.g., any of the methods (1) to (4)) on the reception bit sequence so as to correctly receive the reception bit sequence from the remote unit 4. When the inversion of the sign of the fixed bit pattern is not detected (NO in step S12), the base unit 5 skips step S13.

According to this embodiment, it is possible to automatically determine which of the reception bit sequences from the remote units 4 should be inverted. This eliminates the need to preliminarily set, in the base unit 5, information identifying the remote units 4 from which the reception bit sequences should be inverted, resulting in a reduction in workload of the setting work by the operator.

### Third Embodiment

In this embodiment, a modified example will be described in which the number of the power lines 2 passing through the core of each CT 6 is different from that in FIG. 1. The first embodiment illustrates an example in which two DC power lines 2 (e.g., 2A and 2B) pass through the core of a single CT 6 (e.g., 6A) in opposite directions. Thus, the directions of two direct currents (e.g., IA and IB) passing through the core of the CT 6A are opposite to each other. However, as is understood from the principle of the difference current described in the first embodiment, the number of the power lines 2 passing through the core of a single CT may be an even number equal to or more than 4. Specifically, out of 2N (N is a positive integer) power lines 2, N power lines 2 are allowed to pass through the core of the CT 6 in one direction, while the other N power lines 2 are allowed to pass through the core of the CT 6 in the opposite direction.

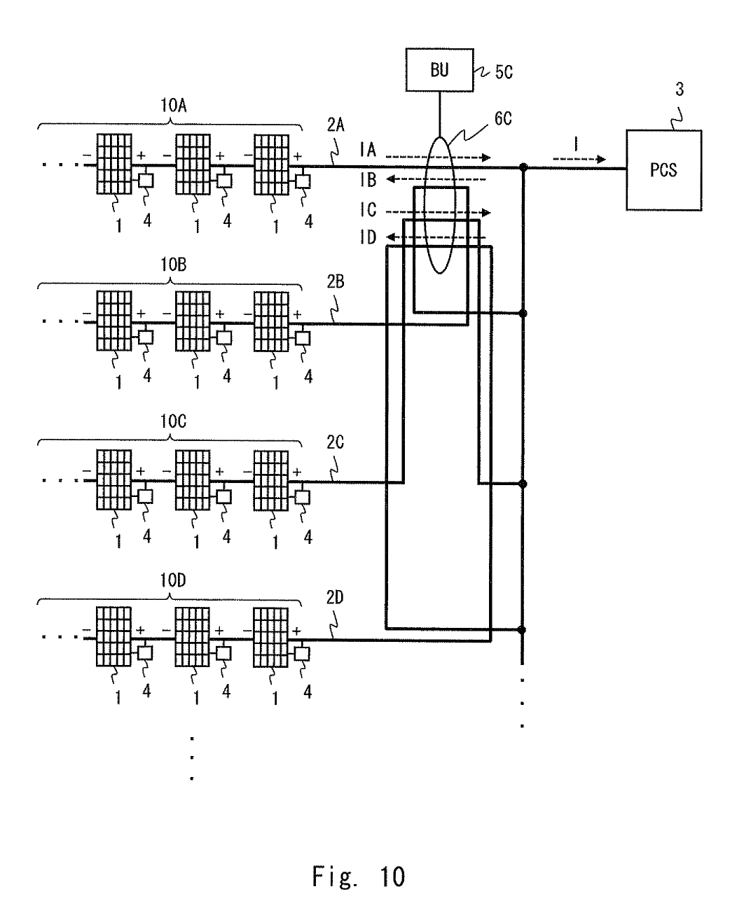

FIG. 10 shows an example in which the four power lines 2A to 2D are disposed so as to pass through the core of a single CT 6C. Specifically, the power lines 2A and 2C pass through the annular core of the CT 6C from the left side to the right side on the drawing sheet of FIG. 10. On the other hand, the power lines 2B and 2D pass through the annular core of the CT 6C from the right side to the left side on the drawing sheet of FIG. 10.

A base unit 5C shown in FIG. 10 can communicate with remote units 4 belonging to the four RU groups respectively connected to the power lines 2A to 2D.

The employment of the configuration described in this embodiment has an advantage of reducing the number of the base units 5. This embodiment is particularly effective when the base units 5 have a sufficient processing power, or the upper limit of the number of multiple accesses is sufficiently high, as compared with the number of the remote units 4 connected to a single power line 2.

### Fourth Embodiment

The first to third embodiments described above illustrate an example where the configuration in which two power lines 2 pass through the core of a single CT 6 in opposite directions is used to detect a change in the difference current between the currents flowing through the two power lines 2. However, such a configuration is merely an example of the current detection unit that detects a change in the difference current between currents flowing through two power lines 2. In this embodiment, another configuration example of the current detection unit will be described.

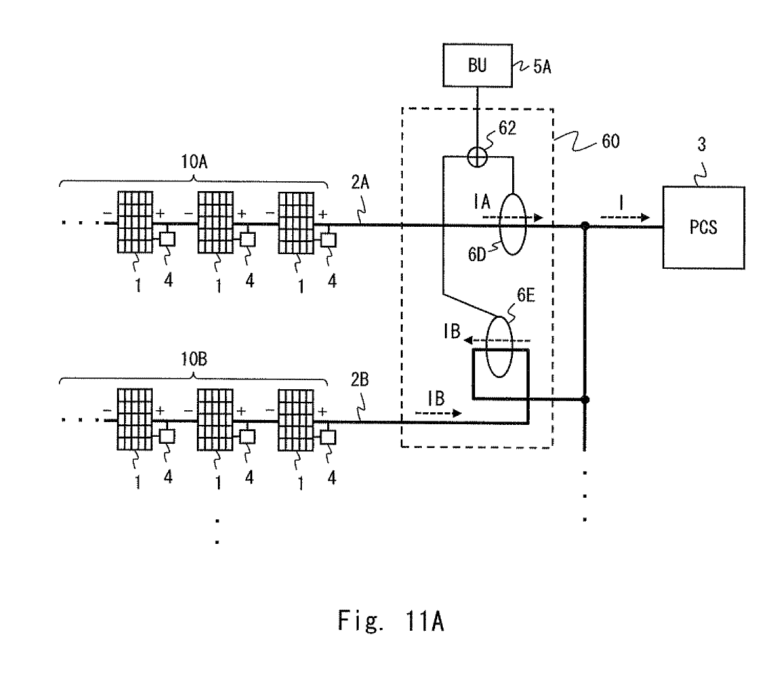

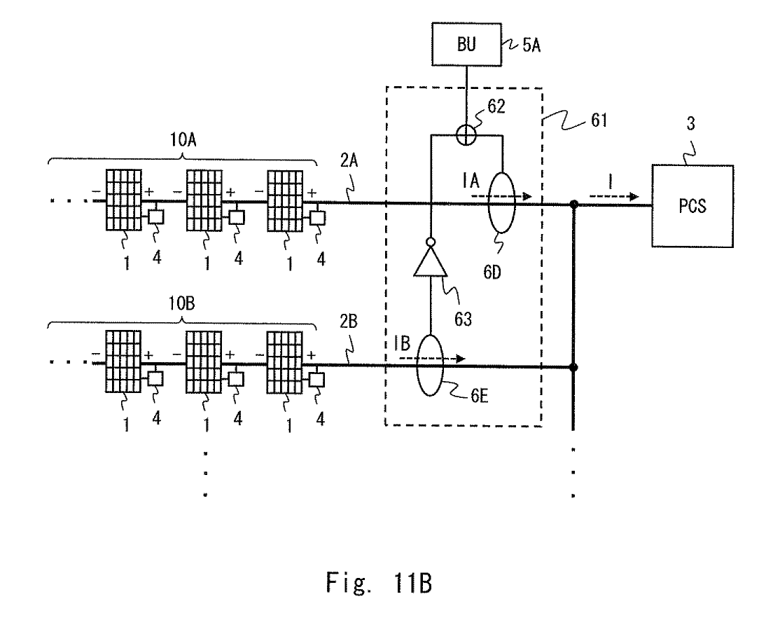

FIGS. 11A and 11B respectively show first and second configuration examples of the photovoltaic power generation system according to this embodiment. As is obvious from the comparison between FIGS. 11A and 11B and FIG. 1, the configuration examples shown in FIGS. 11A and 11B respectively use current detection units 60 and 61, each of which includes two CTs 6D and 6E, instead of a single CT 6A. In the current detection unit 60 shown in FIG. 11A, the power line 2A passes through the core of the CT 6D and the power line 2B passes through the core of the CT 6E. However, the direction in which the power line 2B passes through the core of the CT 6E is opposite to the direction in which the power line 2A passes through the core of the CT 6D. Thus, the direction in which the direct current IB passes through the CT 6E is opposite to the direction in which the direct current IA passes through the CT 6D.

An adder 62 shown in FIG. 11A provides to the base unit 5A a signal obtained by adding output signals of the CTs 6D and 6E. The signal obtained by adding the output signals of the CTs 6D and 6E represents a change in the difference current between the two currents IA and IB flowing respectively through the two power lines 2A and 2B. Accordingly, the base unit 5A can identify and receive the reception bit sequence of each remote unit 4 included in the RU groups A and B, by using the output signal of the adder 62.

In the current detection unit 61 shown in FIG. 11B, the direct currents IA and IB pass through the CTs 6D and 6E, respectively, in the same direction. Accordingly, in FIG. 11B, an inverting amplifier 63 is used to invert the output signal of the CT 6E. The adder 62 shown in FIG. 11B adds the output signal of the CT 6D to the inverted signal obtained by inverting the output signal of the CT 6E. As a result, the output signal of the adder 62 represents a change in the difference current between the two currents IA and IB flowing through the two power lines 2A and 2B. This allows the base unit 5A to identify and receive the reception bit sequence of each remote unit 4 included in the RU groups A and B, by using the output signal of the adder 62. Alternatively, as a method in which the inverting amplifier 63 shown in FIG. 11B is not used, the outputs of the CTs 6D and 6E may be connected to the adder 62 so that they have opposite polarities.

When the configuration examples (e.g., FIG. 1) of the first to third embodiments are compared with the configuration examples (FIGS. 11A and 11B) of this embodiment, the configuration examples of the first to third embodiments have an advantage of reducing the number of CTs. In the configuration examples shown in FIGS. 11A and 11B, if there is a difference between the characteristics of the two CTs 6D and 6E, the reception quality of the base unit 5A may deteriorate. On the other hand, in the configuration examples of the first to third embodiments, the difference current (summed current) between currents flowing through power lines 2 is detected by a single CT 6, which is advantageous in that the deterioration in reception quality of the base units 5 due to variations in the characteristics of the CTs 6 does not occur in principle.

### Other Embodiments

The first to third embodiments described above illustrate examples in which an even number of power lines 2 pass through the core of the CT 6. However, an odd number equal to or more than 3 of power lines 2 may be allowed to pass through the core of the CT 6. In the configuration in which an odd number of power lines 2 are allowed to pass through the core of the CT 6, when the adder 62 adds two signals, the number of times when the power lines pass through the core of the CT 6 may be changed or the value of the load resistor of the CT 6 may be set so that a magnification ratio becomes equal to the ratio of the inverse number of the number of power lines passing through the CT 6. For example, when three power lines are allowed to pass through the core of the CT 6, assuming that two power lines pass through the annular core in the same direction and one power line passes through the annual core in the opposite direction, it is sufficient to allow the one power line, which passes through the core in the opposite direction, to pass through a single core twice. This makes it possible to cancel the electric signals sent from the remote units 4 connected to the other power lines. The output signal of the adder 62 represents a change in the difference current between the two currents IA and IB flowing respectively through the two power lines 2A and 2B. This allows the base unit 5A to identify and receive the reception bit sequence of each remote unit 4 included in the RU groups A and B, by using the output signal of the adder 62. In the fourth embodiment described above, instead of allowing the electric wires to pass through the annular core twice, the value of the load resistor of each CT 6 passing through the annular core in the opposite direction is doubled, thereby making it possible to cancel the electric signals which are sent from the remote units 4 connected to the other power lines input to the adder 62.

The first to fourth embodiments described above illustrate examples in which a current transformer(s) is used to detect a change in the difference current between currents flowing through two power lines 2. However, instead of a current transformer(s), other current detection units capable of detecting a change in the difference current between currents flowing through two power lines 2 may be used. For example, a current detection unit including a Hall element or a shunt resistor may be used. In the case of using a Hall element or a shunt resistor, an analog differentiator or a digital differentiator may be used to observe a change in the difference current due to current signals transmitted from a plurality of remote units 4, by removing effects of a difference (i.e., a pure DC component or an average value) between the generated currents of the solar cell strings 10. The digital differentiator may be integrated with the receiver 51 (e.g., the signal processing unit 54) of the base unit 5.

The first to fourth embodiments described above illustrate an example in which the multiple access communication system is used to monitor the photovoltaic power generation system. However, the technical ideas shown in the first to fourth embodiments can also be applied to, for example, a PLC (Power Line Communication) system using AC power lines as transmission lines. Furthermore, the technical ideas shown in the first to fourth embodiments can be widely applied to multiple access communication systems that use electric wires, which are connected in parallel, as transmission lines.

Moreover, the embodiments described above are merely examples relating to the application of the technical ideas obtained by the present inventors. That is, the technical ideas are not limited to the above embodiments and can be modified in various manners, as a matter of course.

### REFERENCE SIGNS LIST

1 SOLAR CELL PANEL
2, 2A, 2B, 2C, 2D DC POWER LINES
3 POWER CONDITIONER (PCS)
4 REMOTE UNIT (RU)
5, 5A, 5B, 5C BASE UNITS (BU)
6A, 6B, 6C, 6D, 6E CURRENT TRANSFORMERS (CT)
10, 10A, 10B, 10C, 10D SOLAR CELL STRINGS
40A, 40B REMOTE UNIT (RU) GROUPS
41 MEASUREMENT CIRCUIT
42 TRANSMITTER
43 SIGNAL PROCESSING UNIT
44 DRIVER
51 RECEIVER
52 LOW-PASS FILTER (LPF)
53 AD CONVERTER (ADC)
54 SIGNAL PROCESSING UNIT
IA CURRENT FLOWING THROUGH POWER LINE 2A
IB CURRENT FLOWING THROUGH POWER LINE 2B
IC CURRENT FLOWING THROUGH POWER LINE 2C
ID CURRENT FLOWING THROUGH POWER LINE 2D
I CURRENT SUPPLIED TO POWER CONDITIONER 3
60, 61 CURRENT DETECTION UNITS
62 ADDER
63 INVERTING AMPLIFIER

1. A multiple access communication system comprising:
a plurality of electric wires connected in parallel and including first and second electric wires;
a plurality of transmitter groups including a first transmitter group that transmits a signal on the first electric wire and a second transmitter group that transmits a signal on the second electric wire, each of the transmitter groups including at least one transmitter;
a first current detection unit coupled to the first and second electric wires; and
a first receiver coupled to the first current detection unit, the first receiver and the first and second transmitter groups constituting a first multiple access communication system, wherein
each transmitter belonging to the first transmitter group operates to transmit, on the first electric wire, a current signal representing a change in current in accordance with a transmission bit sequence,
each transmitter belonging to the second transmitter group operates to transmit, on the second electric wire, a current signal representing a change in current in accordance with a transmission bit sequence,
the first current detection unit operates to output a first electric signal representing a change in a difference current between a first current flowing through the first electric wire and a second current flowing through the second electric wire, and
the first receiver operates to identify and receive a reception bit sequence corresponding to the transmission bit sequence of each transmitter included in the first and second transmitter groups, by processing the first electric signal.

2. The multiple access communication system according to claim 1, wherein
the first electric signal represents a change in a summed current of the first current and a current whose phase is inverted relative to the second current, and
the first receiver operates to perform phase inversion processing on the reception bit sequence to correctly receive the reception bit sequence from the second transmitter group.

3. The multiple access communication system according to claim 2, wherein
the transmission bit sequence includes a predetermined bit pattern having at least a 1-bit length, and
the first receiver operates to detect a sign of the bit pattern contained in the reception bit sequence from each transmitter and to selectively perform the phase inversion processing on the reception bit sequence with the sign of the bit pattern inverted.

4. The multiple access communication system according to claim 2, wherein the phase inversion processing includes one of:
(a) inverting a phase of the reception bit sequence generated from the first electric signal;
(b) inverting a sign of a spreading code used for despreading processing to obtain the reception bit sequence;
(c) inverting a phase of a reception symbol sequence or a reception chip sequence generated from the first electric signal; and
(d) changing a method for determining a symbol used for demodulation processing to obtain the reception bit sequence.

5. The multiple access communication system according to claim 1, wherein
the first electric signal represents a change in a summed current of the first current and a current whose phase is inverted relative to the second current, and
each transmitter included in the second transmitter group operates to generate the current signal based on a signal whose phase is inverted relative to the transmission bit sequence.

6. The multiple access communication system according to claim 1, further comprising a second current detection unit and a second receiver, wherein
the plurality of electric wires further include third and fourth electric wires,
the plurality of transmitter groups further include a third transmitter group that transmits a signal on the third electric wire and a fourth transmitter group that transmits a signal on the fourth electric wire,
each transmitter belonging to the third transmitter group operates to transmit, on the third electric wire, a current signal representing a change in current in accordance with a transmission bit sequence,
each transmitter belonging to the fourth transmitter group operates to transmit, on the fourth electric wire, a current signal representing a change in current in accordance with a transmission bit sequence,
the second current detection unit operates to output a second electric signal representing a change in a difference current between a third current flowing through the third electric wire and a fourth current flowing through the fourth electric wire, and
the second receiver and the third and fourth transmitter groups constitute a second multiple access communication system, and the second receiver operates to identify and receive a reception bit sequence corresponding to the transmission bit sequence of each transmitter included in the third and fourth transmitter groups, by processing the second electric signal.

7. The multiple access communication system according to claim 6, wherein the first and second transmitter groups share transmission resources for multiple accesses with the third and fourth transmitter groups.

8. The multiple access communication system according to claim 7, wherein the transmission resources includes at least one of code resources, time resources, and frequency resources.

9. The multiple access communication system according to claim 1, wherein
the first current detection unit comprises a current transformer,
the first electric wire is disposed to pass through an annular core of the current transformer,
the second electric wire is disposed to pass through the annular core in a direction opposite to that of the first electric wire, and
the first electric signal is a voltage signal or a current signal output from a secondary side of the current transformer.

10. The multiple access communication system according to claim 1, wherein
the first current detection unit includes first and second current transformers,
the first electric wire is disposed to pass through an annular core of the first current transformer,
the second electric wire is disposed to pass through an annular core of the second current transformer, and
the first electric signal is a signal obtained by addition or subtraction of output voltages or output currents of the first and second current transformers.

11. A photovoltaic power generation system comprising:
the multiple access communication system according to claim 1;
a plurality of solar cell strings respectively connected to the plurality of electric wires; and
a power conditioner that receives DC power generated by the plurality of solar cell strings through the plurality of electric wires, and converts the DC power into AC power.

12. The photovoltaic power generation system according to claim 11, wherein each transmitter operates to generate the transmission bit sequence in which monitoring data on a solar cell panel included in each of the solar cell strings is encoded.

13. A multiple access communication system comprising:
a plurality of electric wires connected in parallel and including first and second electric wires;
a plurality of transmitter groups including a first transmitter group that transmits a signal on the first electric wire and a second transmitter group that transmits a signal on the second electric wire, each of the transmitter groups including at least one transmitter;
a current transformer coupled to the first and second electric wires; and
a first receiver coupled to the current transformer, the first receiver and the first and second transmitter groups constituting a first multiple access communication system, wherein
each transmitter belonging to the first transmitter group operates to transmit, on the first electric wire, a current signal representing a change in current in accordance with a transmission bit sequence,
each transmitter belonging to the second transmitter group operates to transmit, on the second electric wire, a current signal representing a change in current in accordance with a transmission bit sequence,
the first electric wire is disposed to pass through an annular core of the current transformer,
the second electric wire is disposed to pass through the annular core in a direction opposite to that of the first electric wire, and
the first receiver operates to identify and receive a reception bit sequence corresponding to the transmission bit sequence of each transmitter included in the first and second transmitter groups, by processing a voltage signal or a current signal output from a secondary side of the current transformer.

14. A multiple access communication system comprising:
a plurality of electric wires connected in parallel and including first and second electric wires;
a plurality of transmitter groups including a first transmitter group that transmits a signal on the first electric wire and a second transmitter group that transmits a signal on the second electric wire,
a first current transformer coupled to the first electric wire;
a second current transformer coupled to the second electric wire; and
a first receiver coupled to the first and second current transformers, the first receiver and the first and second transmitter groups constituting a first multiple access communication system, wherein
each transmitter belonging to the first transmitter group operates to transmit, on the first electric wire, a current signal representing a change in current in accordance with a transmission bit sequence,
each transmitter belonging to the second transmitter group operates to transmit, on the second electric wire, a current signal representing a change in current in accordance with a transmission bit sequence,
the first electric wire is disposed to pass through an annular core of the first current transformer,
the second electric wire is disposed to pass through an annular core of the second current transformer,
the first receiver operates to identify and receive a reception bit sequence corresponding to the transmission bit sequence of each transmitter included in the first and second transmitter groups, by processing a signal obtained by addition or subtraction of output voltages or output currents of the first and second current transformers.
